(19) United States
(12) Patent Application Publication
(10) Pub. No.: US 2024/0419163 A1
(43) Pub. Date: Dec. 19, 2024

(54) AUDIO DATA-BASED DEVICE FAILURE PREDICTION USING ARTIFICIAL INTELLIGENCE TECHNIQUES

(71) Applicant: Dell Products L.P., Round Rock, TX (US)

(72) Inventors: Shree Rathinasamy, Round Rock, TX (US); Franklin Jebadoss Mohandoss, Austin, TX (US); Bijan Kumar Mohanty, Austin, TX (US)

(21) Appl. No.: 18/210,227

(22) Filed: Jun. 15, 2023

(51) Int. Cl. G05B 23/02

(52) U.S. Cl. CPC G05B 23/0283

(57) ABSTRACT

Methods, apparatus, and processor-readable storage media for audio data-based device failure prediction using artificial intelligence techniques are provided herein. An example computer-implemented method includes obtaining audio data associated with at least one device; modifying at least a portion of the obtained audio data using one or more data processing techniques; predicting at least one failure associated with the at least one device by classifying, into at least one of multiple device failure-related categories, at least a portion of the modified audio data using one or more artificial intelligence techniques; and performing one or more automated actions based at least in part on the classifying of the at least a portion of the modified audio data.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Enterprise resources such as data centers and cloud environments often require scaling as enterprise needs change and/or grow, wherein such scaling can result in an increase in devices including hardware such as servers, storage, network switches, routers, etc., as well as associated accessories such as fiber cables, copper, racks, etc. Additionally, many such devices fail and/or degrade gradually and/or incrementally, and as such, monitoring device statuses presents challenges. However, conventional device management approaches often rely on reactive analysis of text-based log information, resulting in data loss, device downtime, energy inefficiencies, resource wastage, etc.

### SUMMARY

Illustrative embodiments of the disclosure provide techniques for audio data-based device failure prediction using artificial intelligence techniques.

An exemplary computer-implemented method includes obtaining audio data associated with at least one device, and modifying at least a portion of the obtained audio data using one or more data processing techniques. Additionally, the method includes predicting at least one failure associated with the at least one device by classifying, into at least one of multiple device failure-related categories, at least a portion of the modified audio data using one or more artificial intelligence techniques. Further, the method also includes performing one or more automated actions based at least in part on the classifying of the at least a portion of the modified audio data.

Illustrative embodiments can provide significant advantages relative to conventional device management approaches. For example, problems and/or issues associated with reactive analysis of text-based log information are overcome in one or more embodiments through predicting device failure information by processing device-related audio data using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for audio data-based device failure prediction using artificial intelligence techniques in an illustrative embodiment.

FIG. 2 shows example system architecture in an illustrative embodiment.

FIG. 3 shows example architecture of an audio data processing engine in an illustrative embodiment.

FIG. 4 shows example pseudocode for implementing a band-pass filter in an illustrative embodiment.

FIG. 5 shows example pseudocode for implementing one or more audio analysis libraries in an illustrative embodiment.

FIG. 6 shows example pseudocode for classifying audio data in an illustrative embodiment.

FIG. 7 shows example pseudocode for implementing a frequency distribution in connection with input audio data in an illustrative embodiment.

FIG. 8 shows example pseudocode for compiling and training an audio signal classification neural network in an illustrative embodiment.

FIG. 9 shows example pseudocode for testing a trained neural network in an illustrative embodiment.

FIG. 10 is a flow diagram of a process for audio data-based device failure prediction using artificial intelligence techniques in an illustrative embodiment.

FIGS. 11 and 12 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

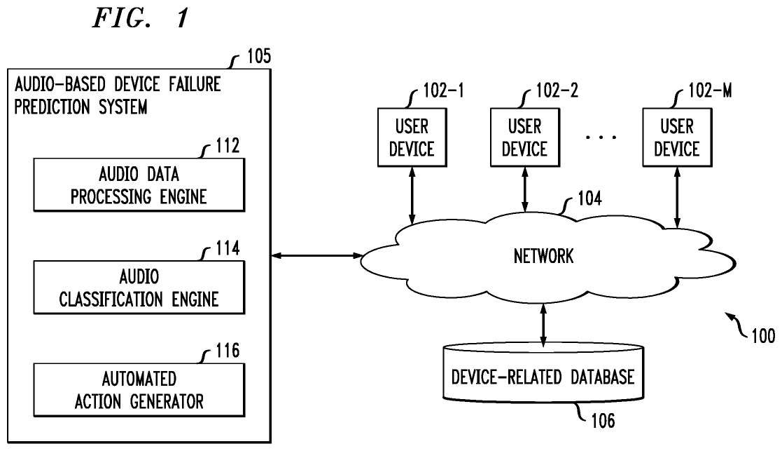

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the example FIG. 1 embodiment. Also coupled to network 104 is audio-based device failure prediction system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, audio-based device failure prediction system 105 can have an associated device-related database 106 configured to store data pertaining to device-specific audio, device-specific issues, device-specific componentry information, device log information, etc.

The device-related database 106 in the present embodiment is implemented using one or more storage systems associated with audio-based device failure prediction system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with audio-based device failure prediction system 105 are one or more input-output devices, which illustratively comprise keyboards, displays or other types of input-output devices in any combination. Such input-output devices can be used, for example, to support one or more user interfaces to audio-based device failure prediction system 105, as well as to support communication between audio-based device failure prediction system 105 and other related systems and devices not explicitly shown.

Additionally, audio-based device failure prediction system 105 in the FIG. 1 embodiment is assumed to be implemented using at least one processing device. Each such processing device generally comprises at least one processor and an associated memory, and implements one or more functional modules for controlling certain features of audio-based device failure prediction system 105.

More particularly, audio-based device failure prediction system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory can illustratively comprise random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture,” as used herein, should be understood to exclude transitory, propagating signals. These and other references to “disks” herein are intended to refer generally to storage devices, including solid-state drives (SSDs), and should therefore not be viewed as limited in any way to spinning magnetic media.

The network interface allows audio-based device failure prediction system 105 to communicate over the network 104 with the user devices 102, and illustratively comprises one or more conventional transceivers.

The audio-based device failure prediction system 105 further comprises audio data processing engine 112, audio classification engine 114, and automated action generator 116.

It is to be appreciated that this particular arrangement of elements 112, 114 and 116 illustrated in the audio-based device failure prediction system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for audio data-based device failure prediction using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, audio-based device failure prediction system 105 and device-related database 106 can be on and/or part of the same processing platform. By way of further example, in one or more embodiments, audio-based device failure prediction system 105 can be deployed within or otherwise in association with a data center.

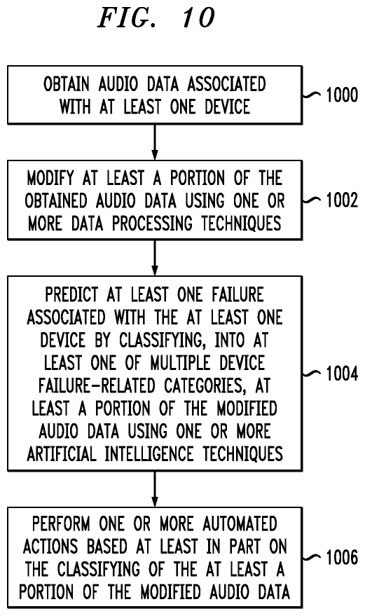

An exemplary process utilizing elements 112, 114 and 116 of an example audio-based device failure prediction system 105 in computer network 100 will be described in more detail with reference to the flow diagram of FIG. 10.

Accordingly, at least one embodiment includes audio data-based device failure prediction using artificial intelligence techniques. As detailed herein, many devices and/or components thereof are prone to failures due to issues and/or problems, and such devices and/or components thereof often create and/or emit noises in connection with operations. By way of example, a number of GPUs can include one or more heatsinks and/or fans which help in dissipating the heat generated by the GPUs, and a heatsink and/or fan can generate certain noises, for instance, when the GPU is stressed or if the heatsink and/or fan is not working properly.

As such, one or more embodiments include predicting device-specific degradation and/or failure by processing one or more audio signals generated and/or emitted from the given device. Such audio signals can be captured, for example, by one or more auditory sensors, and the device-specific degradation and/or failure prediction can include predicting the type(s) of degradation and/or failure. As further detailed herein, at least one embodiment includes leveraging at least one audio data processing engine and at least one neural network-based audio classification engine to predict at least one class of device-specific degradation and/or failure. By implementing preemptive device-specific degradation and/or failure prediction from audio signals, such an embodiment can include performing one or more automated actions related to early intervention, thus reducing and/or minimizing device-related outages.

By way merely of example and illustration, consider a use case involving hard disk drives, which can be enclosed in at least one baffle with one or more auditory sensors implemented and/or attached thereto to capture sound generated by the drives. Captured analog signals are processed and/or converted to digital signals and stored (e.g., in the form of one or more audio wave files) for further processing, and one or more logs can also be acquired in connection with the drives and/or components thereof.

In such an example use case, different audio waves generated by the hard disk drives can be processed (e.g., using at least one neural network) and classified as follows: audio1.wav is classified as grinding or scratching sounds associated with physical damage to one or more moving parts (potentially linked to loss of data); audio2.wav is classified as extreme whirring sounds created by abnormal vibration and associated with a faulty drive that can fail; audio3.wav is classified as repeated hard clicking or clunking sounds associated with at least one physical component issue in a drive; and audio4.wav is classified as intense humming and cracking sounds associated with at least one issue with a power supply to a drive.

Accordingly, one or more embodiments include leveraging at least one audio filtering mechanism for preprocessing device-generated audio data, and analyzing such preprocessed audio data using at least one neural network to classify at least a portion of the audio data into one or more of multiple device issue-related categories or classes. Such an embodiment can include analyzing audio log data generated, for example, by audio sensors for multiple types of operation settings including ambient noise, and predicting at least one type of issue associated with the given audio signal(s). Further, at least one embodiment can include generating such predictions by leveraging one or more machine learning models to analyze the audio log data and using at least one classifier trained using historical device-specific issue data. In one or more embodiments, classifiers can be built and/or trained using shallow learning techniques or deep learning techniques. With a shallow learning approach, algorithms such as logistic regression, support vector machines (SVMs), and/or ensemble decision tree classifiers (e.g., random forest, gradient boosting, etc.) can be used. With a deep learning approach, at least one multi-layered neural network can be used to act as a classifier (such as, for example, further detailed herein in connection with one or more embodiments).

FIG. 2 shows example system architecture in an illustrative embodiment. By way of illustration, FIG. 2 depicts a data center 202 with an audio sensor 220 linked thereto and/or otherwise associated therewith, wherein audio sensor 220 captures sound data generated by and/or ambient to data center 202. At least a portion of such sound data is then processed by connected devices 222 and audio-based device failure prediction system 205. Connected devices 222 can include, by way of example, at least a portion of one or more data monitoring systems, and can also include at least one client component deployed natively on user systems and at least one server component that receives audio signal files from the client as monitoring data. As also depicted in FIG. 2, within audio-based device failure prediction system 205, audio data processing engine 212 and audio classification engine 214 process the sound data and generate and/or output one or more audio classifications 224 (e.g., such as a grinding classification, a clunking classification, a whirring classification, and/or a cracking classification). Although shown as separate from data center 202 in this example, one or more of components 220 through 224 may instead be implemented at least in part within the data center 202.

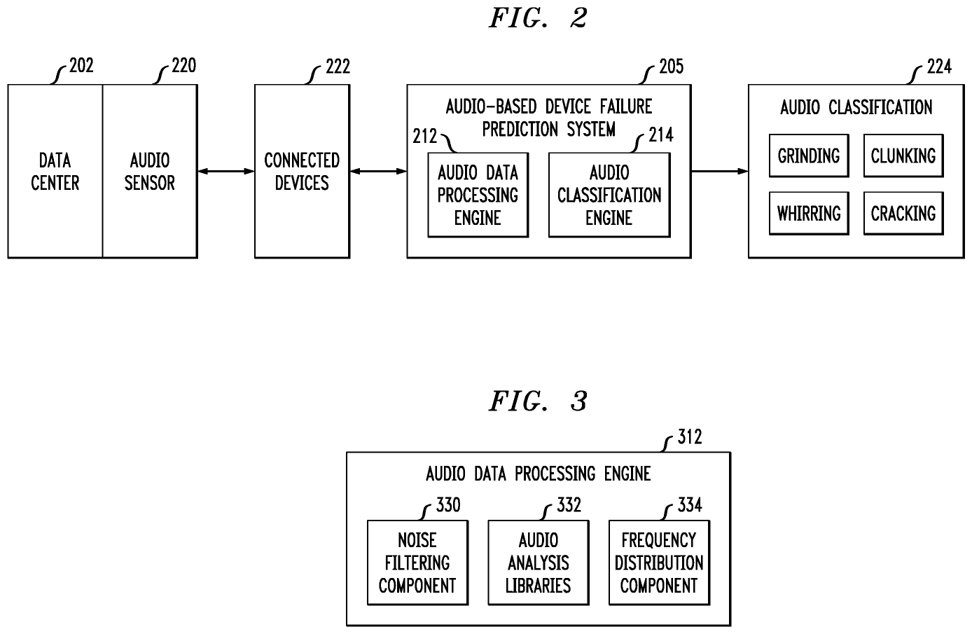

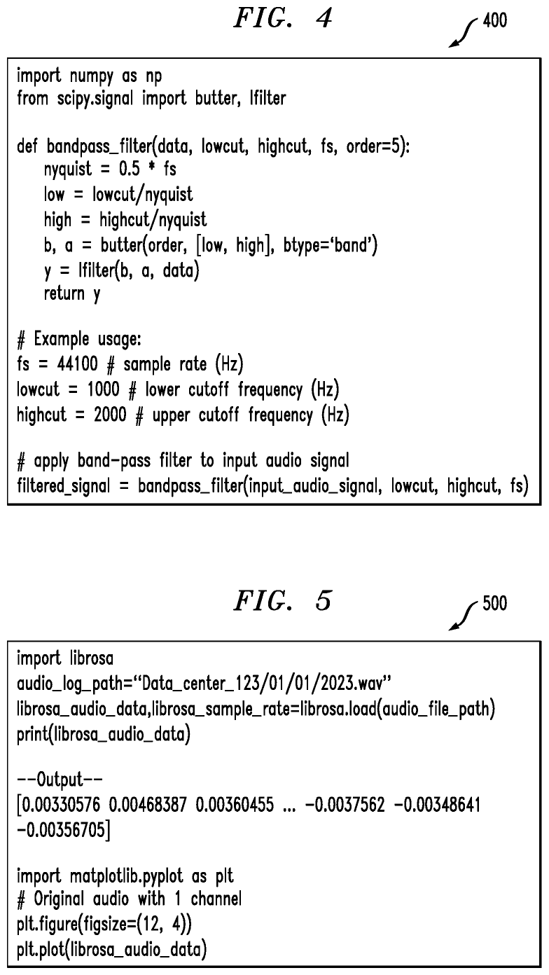

In such an example embodiment as depicted in FIG. 2, audio data processing engine 212 processes the audio data from data center 202, wherein such audio data can be captured by on-device auditory sensor 220 and sent via connected devices 222. In one or more embodiments, such as further detailed in connection with FIG. 3, audio data processing engine 212 processes audio data in multiple stages.

FIG. 3 shows example architecture of an audio data processing engine in an illustrative embodiment. By way of illustration, FIG. 3 depicts audio data processing engine 312, and more specifically, a noise filtering component 330, one or more audio analysis libraries 332 (e.g., Librosa libraries), and a frequency distribution component 334 therein.

With respect to noise filtering component 330, data centers (e.g., data center 202 in the FIG. 2 example embodiment) can generate a significant amount of noise due to the cooling systems and other equipment used to keep the servers and other electronics at desired temperatures. In such a use case, one or more embodiments include filtering out and/or eliminating noise, from the captured sound data, which is not related to one or more failure-related classifications. Accordingly, such an embodiment includes implementing noise filtering component 330, which can include using one or more band-pass filters to reduce the frequency range of the captured sound data generated by data centers.

FIG. 4 shows example pseudocode for implementing a band-pass filter in an illustrative embodiment. In this embodiment, example pseudocode 400 is executed by or under the control of at least one processing system and/or device. For example, the example pseudocode 400 may be viewed as comprising a portion of a software implementation of at least part of audio-based device failure prediction system 105 of the FIG. 1 embodiment.

The example pseudocode 400 illustrates defining a band-pass filter, which refers to a type of filter that allows frequencies within a certain range to pass through, while attenuating and/or rejecting frequencies outside of this range. Such a filter can be useful, for example, for removing ambient noise from an audio signal, as ambient noise is often at a different frequency range than the desired audio signal. To apply a band-pass filter to an audio signal, the input audio signal is passed through a filter circuit that is designed to allow only a specific frequency range to pass through. The cutoff frequencies of the filter determine which frequencies are included and which frequencies are excluded from the above-noted range. Also, the output of the filter includes the filtered audio signal (e.g., the audio signal with reduced ambient noise). Additionally, one or more specific parameters of the band-pass filter, such as the cutoff frequencies and the slope of the filter, can be adjusted to optimize the removal of the ambient noise while preserving the desired audio signal.

By way of specific illustration, example pseudocode 400 illustrates importing and using the butter function from the SciPy library to generate the filter coefficients for a Butterworth band-pass filter of a specified order. The lfilter function is then used to apply the filter to the input audio signal. The lowcut and highcut parameters specify the lower and upper cutoff frequencies, respectively, and fs represents the sample rate of the audio signal.

It is to be appreciated that this particular example pseudocode shows just one example implementation of a band-pass filter, and alternative implementations can be used in other embodiments.

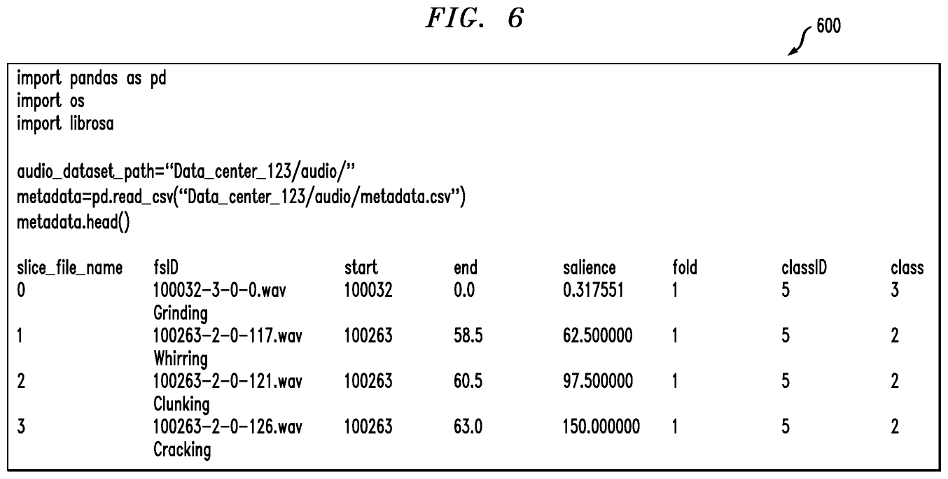

Referring again to FIG. 3, at least one embodiment includes implementing one or more audio analysis libraries 332 to determine a sample rate, as further detailed in FIG. 5. A sample rate is a factor in audio processing which determines the level of detail in the representation of the audio signal. For example, the sample rate can determine the number of samples that are taken from the audio signal per second, wherein a higher sample rate means that more samples are taken per second, resulting in a more detailed representation of the audio signal.

FIG. 5 shows example pseudocode for implementing one or more audio analysis libraries in an illustrative embodiment. In this embodiment, example pseudocode 500 is executed by or under the control of at least one processing system and/or device. For example, the example pseudocode 500 may be viewed as comprising a portion of a software implementation of at least part of audio-based device failure prediction system 105 of the FIG. 1 embodiment.

The example pseudocode 500 illustrates importing a Librosa library and processing input audio logs and/or signals derived from a data center to determine a sample rate. Additionally, example pseudocode 500 illustrates audio metadata used for training a classifier. As shown in a tabular format (e.g., as an output of the metadata.head( ) function), different audio file names and their class (e.g., type of issue) can be identified. Also, example pseudocode 500 illustrates using matplotlib, a python library, to plot one or more related graphs.

It is to be appreciated that this particular example pseudocode shows just one example implementation of one or more audio analysis libraries, and alternative implementations can be used in other embodiments.

Referring again to FIG. 3, at least one embodiment includes implementing frequency distribution, via frequency distribution component 334, using Mel-frequency cepstral coefficients (MFCCs), which pertain to a feature extraction technique in audio signal processing. For example, MFCCs can represent an audio signal in a compact form that is based at least in part on the perceptual properties of the human ear. By converting an audio signal into MFCCs, at least one embodiment can include extracting meaningful information about the audio signal that is useful for classification purposes.

In one or more embodiments, MFCCs summarize the frequency distribution across a window size, facilitating analysis of both the frequency and time characteristics of the sound. Such audio representations can assist and/or enable identification of one or more features for classification. By way of example, such an embodiment can include determining the sample rate from an audio signal using a Librosa library, and subsequently using MFCCs to represent the audio signal in a format that is useful for one or more audio processing tasks (e.g., predicting and/or classifying device and/or device component failures using device-generated sounds (for example, grinding sounds, clunking sounds, whirring sounds, and cracking sounds that can each be associated with at least one specific device failure), wherein each sound has its own frequency and is classified by the frequency of its audio signal).

FIG. 6 shows example pseudocode for classifying audio data in an illustrative embodiment. In this embodiment, example pseudocode 600 is executed by or under the control of at least one processing system and/or device. For example, the example pseudocode 600 may be viewed as comprising a portion of a software implementation of at least part of audio-based device failure prediction system 105 of the FIG. 1 embodiment.

The example pseudocode 600 illustrates importing one or more audio analysis libraries and using such libraries, in part, to classify portions of one or more audio files into different classes before feature extraction using MFCCs. Additionally, example pseudocode 600 illustrates four types of issue classes (grinding, whirring, clunking, and cracking), wherein processed audio files can fall under one of these four issue categories.

It is to be appreciated that this particular example pseudocode shows just one example implementation of classifying audio data, and alternative implementations can be used in other embodiments.

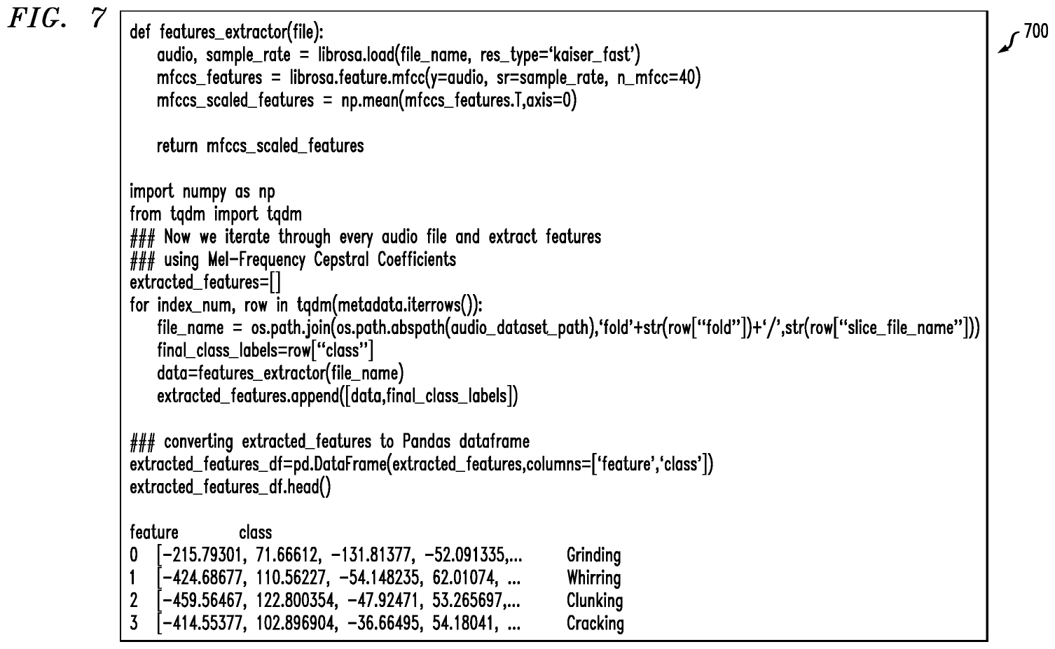

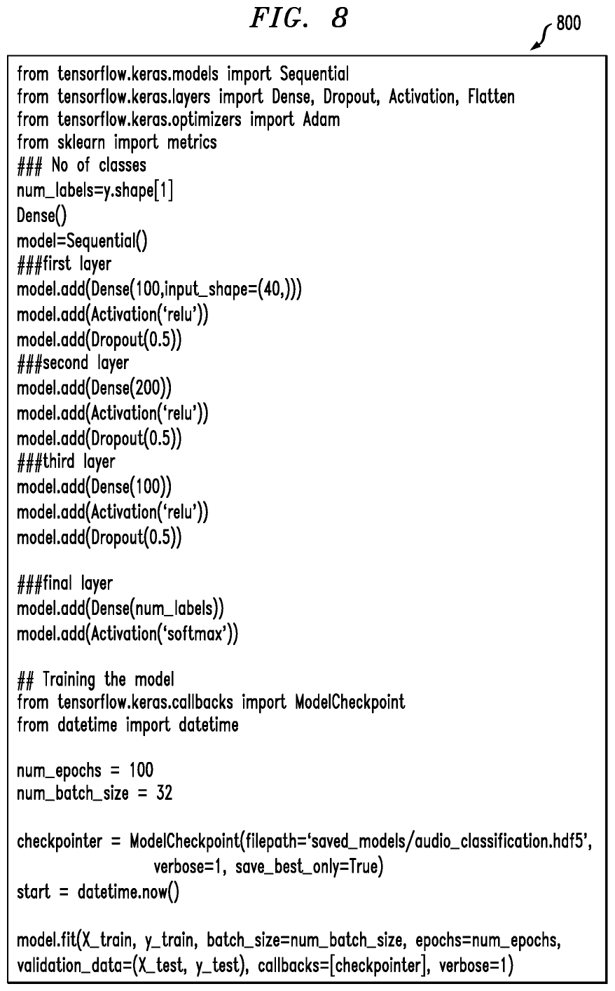

FIG. 7 shows example pseudocode for implementing a frequency distribution in connection with input audio data in an illustrative embodiment. In this embodiment, example pseudocode 700 is executed by or under the control of at least one processing system and/or device. For instance, the example pseudocode 700 may be viewed as comprising a portion of a software implementation of at least part of audio-based device failure prediction system 105 of the example FIG. 1 embodiment.

The example pseudocode 700 illustrates implementing a frequency distribution and a map with the class name of the issue, determined based at least in part on input audio logs in connection with using MFCCs. Additionally, example pseudocode 700 illustrates defining multiple features, processing data using MFCCs, and converting extracted features to a Pandas dataframe.

It is to be appreciated that this particular example pseudocode shows just one example implementation of a frequency distribution in connection with input audio data, and alternative implementations can be used in other embodiments.

Referring again to FIG. 1 and FIG. 2, one or more embodiments include implementing at least one audio classification engine, which classifies audio signals into various classes of device failure-related issues. Further, once such issues are classified based at least in part on the device-generated noise, appropriate action can be taken automatically such as, for example, creating a case in a customer relationship management (CRM) system, initiating one or more operations team action, etc.

As part of an audio classification engine, one or more embodiments include implementing at least one sequential model from one or more artificial neural networks for audio signal classification. In such an embodiment, a sequential model includes a linear stack of layers that can be used to build complex neural networks. In an audio signal classification context, a sequential model can be used to train a neural network to classify different types of audio signals (such as, for example, grinding sounds, whirring sounds, clunking sounds, cracking sounds, etc.). The sequential model is trained on at least one dataset of audio signals and their corresponding labels.

By way of example, the input to an audio signal classification neural network can include, for example, a feature representation of an audio signal, such as the MFCCs, which are extracted from the audio signal using at least one feature extraction algorithm as part of an audio preprocessing engine (such as depicted in FIG. 1 and FIG. 2). The MFCCs are then fed into the input layer of the neural network, which is connected to one or more hidden layers that are used to extract more complex features from the MFCCs. By way merely of example, more complex features can be extracted by adding one or more hidden layers. In an example embodiment, a neural network can be created using three hidden layers, and one or more layers can be added to extract more features, if needed. The final layer of the neural network is the output layer, which is used to make the final classification of the audio signal.

FIG. 8 shows example pseudocode for compiling and training an audio signal classification neural network in an illustrative embodiment. In this embodiment, example pseudocode 800 is executed by or under the control of at least one processing system and/or device. For instance, the example pseudocode 800 may be viewed as comprising a portion of a software implementation of at least part of audio-based device failure prediction system 105 of the example FIG. 1 embodiment.

The example pseudocode 800 illustrates importing one or more models, multiple neural network layers, one or more optimizers, and one or more metrics. In the FIG. 8 example, the neural network being compiled includes four layers, each with an activation function, dense layer information, etc. More specifically, example pseudocode 800 illustrates creating a neural network by using a Keras sequential function and adding three dense hidden layers with 100 neurons in the first layer, 200 neurons in the second layer, and 100 neurons in third layer. Also, a rectified linear unit (ReLU) activation function is used in all three hidden layers and a softmax activation function is used in the final layer. After setting the epoch size to 100 and the training data batch size as 32, the neural network model is trained (using fit( ) function). Such training can also include using at least one supervised learning algorithm such as, e.g., backpropagation, which adjusts the weights of the connections between the layers of the neural network to minimize the error between the predicted and true labels of the training data.

It is to be appreciated that this particular example pseudocode shows just one example implementation of compiling and training an audio signal classification neural network, and alternative implementations can be used in other embodiments.

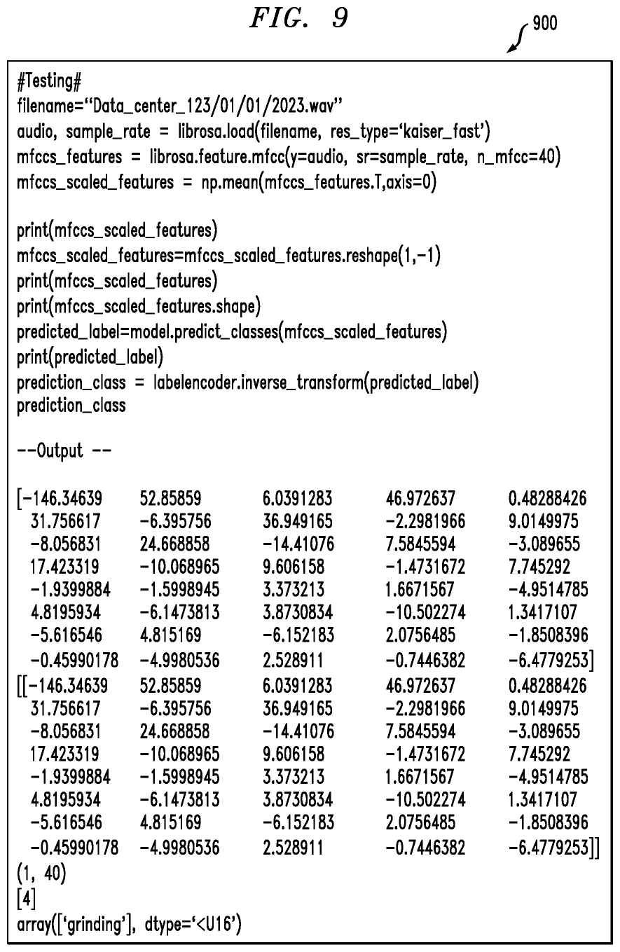

FIG. 9 shows example pseudocode for testing a trained neural network in an illustrative embodiment. In this embodiment, example pseudocode 900 is executed by or under the control of at least one processing system and/or device. For example, the example pseudocode 900 may be viewed as comprising a portion of a software implementation of at least part of audio-based device failure prediction system 105 of the FIG. 1 embodiment.

The example pseudocode 900 illustrates testing the neural network compiled and trained in FIG. 8 via example pseudocode 800. Additionally, as illustrated in example pseudocode 900, the neural network model is queried to predict (model.predict_classes( )) and the predicted values are printed.

It is to be appreciated that this particular example pseudocode shows just one example implementation of testing a trained neural network, and alternative implementations can be used in other embodiments.

It is to be appreciated that some embodiments described herein utilize one or more artificial intelligence models. It is to be appreciated that the term “model,” as used herein, is intended to be broadly construed and may comprise, for example, a set of executable instructions for generating computer-implemented predictions. For example, one or more of the models described herein may be trained to generate device-specific failure-related predictions based on audio data generated by and/or captured approximate to one or more devices, and such predictions can be used to initiate one or more automated actions (e.g., automatically initiating one or more reparative and/or remedial actions with respect to the given device and/or component thereof, automatically tuning at least a portion of the artificial intelligence techniques used in the prediction generating process, automatically outputting one or more notifications to at least one user and/or system, etc.).

FIG. 10 is a flow diagram of a process for audio data-based device failure prediction using artificial intelligence techniques in an illustrative embodiment. It is to be understood that this particular process is only an example, and additional or alternative processes can be carried out in other embodiments.

In this embodiment, the process includes steps 1000 through 1006. These steps are assumed to be performed by the audio-based device failure prediction system 105 utilizing elements 112, 114 and 116.

Step 1000 includes obtaining audio data associated with at least one device. In at least one embodiment, obtaining audio data associated with at least one device includes implementing one or more auditory sensors in connection with the at least one device. Additionally or alternatively, obtaining audio data associated with at least one device can include obtaining audio data generated by the at least one device.

Step 1002 includes modifying at least a portion of the obtained audio data using one or more data processing techniques. In one or more embodiments, modifying at least a portion of the obtained audio data using one or more data processing techniques includes determining at least one sample rate based at least in part on one or more audio analysis libraries, and converting at least a portion of the obtained audio data to one or more digital signals in accordance with the at least one sample rate. Additionally or alternatively, modifying at least a portion of the obtained audio data using one or more data processing techniques can include extracting one or more features from the obtained audio data in connection with using one or more Mel-frequency cepstral coefficients. Further, in one or more embodiments, modifying at least a portion of the obtained audio data using one or more data processing techniques includes filtering out, from the obtained audio data, predefined audio frequencies by processing the obtained audio data using at least one band-pass filter.

Step 1004 includes predicting at least one failure associated with the at least one device by classifying, into at least one of multiple device failure-related categories, at least a portion of the modified audio data using one or more artificial intelligence techniques. In at least one embodiment, classifying at least a portion of the modified audio data includes processing the at least a portion of the modified audio data using at least one neural network trained to classify one or more audio data features into at least one of the multiple device failure-related categories. Also, predicting at least one failure associated with the at least one device can include associating the multiple device failure-related categories with one or more device-specific failures using the one or more artificial intelligence techniques.

Step 1006 includes performing one or more automated actions based at least in part on the classifying of the at least a portion of the modified audio data. In one or more embodiments, performing one or more automated actions includes automatically initiating one or more reparative actions for the at least one device in response to the at least one predicted failure. Additionally or alternatively, performing one or more automated actions can include automatically training at least a portion of the one or more artificial intelligence techniques based at least in part on feedback related to the at least one predicted failure.

Accordingly, the particular processing operations and other functionality described in conjunction with the flow diagram of FIG. 10 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to predict device failure information by processing device-based audio data using artificial intelligence techniques. These and other embodiments can effectively overcome problems associated with reactive analysis of text-based log information.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

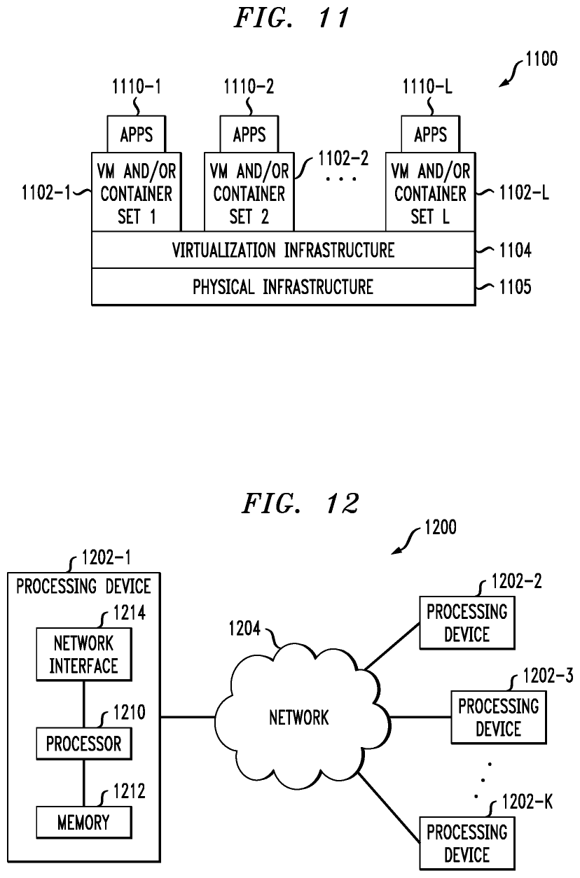

Illustrative embodiments of processing platforms will now be described in greater detail with reference to FIGS. 11 and 12. Although described in the context of system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that are utilized to implement at least a portion of the information processing system 100. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, 1110-L running on respective ones of the VMs/container sets 1102-1, 1102-2, . . . 1102-L under the control of the virtualization infrastructure 1104. The VMs/container sets 1102 comprise respective VMs, respective sets of one or more containers, or respective sets of one or more containers running in VMs. In some implementations of the FIG. 11 embodiment, the VMs/container sets 1102 comprise respective VMs implemented using virtualization infrastructure 1104 that comprises at least one hypervisor.

A hypervisor platform may be used to implement a hypervisor within the virtualization infrastructure 1104, wherein the hypervisor platform has an associated virtual infrastructure management system. The underlying physical machines comprise one or more information processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of system 100 and includes a plurality of processing devices, denoted 1202-1, 1202-2, 1202-3, . . . 1202-K, which communicate with one another over a network 1204.

The network 1204 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1202-1 in the processing platform 1200 comprises a processor 1210 coupled to a memory 1212.

The processor 1210 comprises a microprocessor, a CPU, a GPU, a TPU, a microcontroller, an ASIC, a FPGA or other type of processing circuitry, as well as portions or combinations of such circuitry elements.

The memory 1212 comprises random access memory (RAM), read-only memory (ROM) or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining audio data associated with at least one device;
modifying at least a portion of the obtained audio data using one or more data processing techniques;
predicting at least one failure associated with the at least one device by classifying, into at least one of multiple device failure-related categories, at least a portion of the modified audio data using one or more artificial intelligence techniques; and
performing one or more automated actions based at least in part on the classifying of the at least a portion of the modified audio data;
wherein the method is performed by at least one processing device comprising a processor coupled to a memory.

2. The computer-implemented method of claim 1, wherein modifying at least a portion of the obtained audio data using one or more data processing techniques comprises determining at least one sample rate based at least in part on one or more audio analysis libraries, and converting at least a portion of the obtained audio data to one or more digital signals in accordance with the at least one sample rate.

3. The computer-implemented method of claim 1, wherein modifying at least a portion of the obtained audio data using one or more data processing techniques comprises extracting one or more features from the obtained audio data in connection with using one or more Mel-frequency cepstral coefficients.

4. The computer-implemented method of claim 1, wherein modifying at least a portion of the obtained audio data using one or more data processing techniques comprises filtering out, from the obtained audio data, predefined audio frequencies by processing the obtained audio data using at least one band-pass filter.

5. The computer-implemented method of claim 1, wherein classifying at least a portion of the modified audio data comprises processing the at least a portion of the modified audio data using at least one neural network trained to classify one or more audio data features into at least one of the multiple device failure-related categories.

6. The computer-implemented method of claim 1, wherein predicting at least one failure associated with the at least one device comprises associating the multiple device failure-related categories with one or more device-specific failures using the one or more artificial intelligence techniques.

7. The computer-implemented method of claim 1, wherein performing one or more automated actions comprises automatically initiating one or more reparative actions for the at least one device in response to the at least one predicted failure.

8. The computer-implemented method of claim 1, wherein performing one or more automated actions comprises automatically training at least a portion of the one or more artificial intelligence techniques based at least in part on feedback related to the at least one predicted failure.

9. The computer-implemented method of claim 1, wherein obtaining audio data associated with at least one device comprises implementing one or more auditory sensors in connection with the at least one device.

10. The computer-implemented method of claim 1, wherein obtaining audio data associated with at least one device comprises obtaining audio data generated by the at least one device.

11. A non-transitory processor-readable storage medium having stored therein program code of one or more software programs, wherein the program code when executed by at least one processing device causes the at least one processing device:
to obtain audio data associated with at least one device;
to modify at least a portion of the obtained audio data using one or more data processing techniques;
to predict at least one failure associated with the at least one device by classifying, into at least one of multiple device failure-related categories, at least a portion of the modified audio data using one or more artificial intelligence techniques; and
to perform one or more automated actions based at least in part on the classifying of the at least a portion of the modified audio data.

12. The non-transitory processor-readable storage medium of claim 11, wherein modifying at least a portion of the obtained audio data using one or more data processing techniques comprises determining at least one sample rate based at least in part on one or more audio analysis libraries, and converting at least a portion of the obtained audio data to one or more digital signals in accordance with the at least one sample rate.

13. The non-transitory processor-readable storage medium of claim 11, wherein modifying at least a portion of the obtained audio data using one or more data processing techniques comprises extracting one or more features from the obtained audio data in connection with using one or more Mel-frequency cepstral coefficients.

14. The non-transitory processor-readable storage medium of claim 11, wherein classifying at least a portion of the modified audio data comprises processing the at least a portion of the modified audio data using at least one neural network trained to classify one or more audio data features into at least one of the multiple device failure-related categories.

15. The non-transitory processor-readable storage medium of claim 11, wherein performing one or more automated actions comprises automatically initiating one or more reparative actions for the at least one device in response to the at least one predicted failure.

16. An apparatus comprising:
at least one processing device comprising a processor coupled to a memory;
the at least one processing device being configured:
to obtain audio data associated with at least one device;
to modify at least a portion of the obtained audio data using one or more data processing techniques;
to predict at least one failure associated with the at least one device by classifying, into at least one of multiple device failure-related categories, at least a portion of the modified audio data using one or more artificial intelligence techniques; and
to perform one or more automated actions based at least in part on the classifying of the at least a portion of the modified audio data.

17. The apparatus of claim 16, wherein modifying at least a portion of the obtained audio data using one or more data processing techniques comprises determining at least one sample rate based at least in part on one or more audio analysis libraries, and converting at least a portion of the obtained audio data to one or more digital signals in accordance with the at least one sample rate.

18. The apparatus of claim 16, wherein modifying at least a portion of the obtained audio data using one or more data processing techniques comprises extracting one or more features from the obtained audio data in connection with using one or more Mel-frequency cepstral coefficients.

19. The apparatus of claim 16, wherein classifying at least a portion of the modified audio data comprises processing the at least a portion of the modified audio data using at least one neural network trained to classify one or more audio data features into at least one of the multiple device failure-related categories.

20. The apparatus of claim 16, wherein performing one or more automated actions comprises automatically initiating one or more reparative actions for the at least one device in response to the at least one predicted failure.
